(19) United States
(12) Patent Application Publication
(10) Pub. No.: US 2026/0004507 A1
(43) Pub. Date: Jan. 1, 2026

(54) DENSE GEOMETRY FORMAT ENCODINGS AS BASE MESH FOR SUBDIVISION SURFACES

(71) Applicant: Advanced Micro Devices, Inc., Santa Clara, CA (US)

(72) Inventors: Carsten Benthin, Munich (DE); David Kirk McAllister, Santa Clara, CA (US); Joshua David Barczak, Santa Clara, CA (US)

(73) Assignee: Advanced Micro Devices, Inc., Santa Clara, CA (US)

(21) Appl. No.: 18/758,515

(22) Filed: Jun. 28, 2024

(51) Int. Cl. G06T 15/06; G06T 7/60

(52) U.S. Cl. CPC G06T 15/06; G06T 7/60

(57) ABSTRACT

A geometry compression format is described. The compression format eliminates the need to store duplicate vertex information by storing unique vertices in each compressed data structure. Different triangles can refer to the same vertex using an index value, meaning that even if the same vertex is used multiple times in the compressed data structure, the entirety of the vertex information (e.g., positional information) does not need to be stored multiple times. An improvement includes representing further subdivision of the geometry in an efficient manner to represent highly detailed geometry. The subdivision can be specified by sideband information which can specify any of a variety of types of information.

### BACKGROUND

In image synthesis, ray tracing is utilized to find a nearest intersection of a given ray with a scene where light propagation is simulated. Advances in ray tracing are constantly being made.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 is a block diagram of the device of FIG. 1, illustrating additional detail, according to an example;

FIG. 3 illustrates a ray tracing pipeline for rendering graphics using a ray tracing technique, according to an example;

FIG. 4 is an illustration of a bounding volume hierarchy (“BVH”), according to an example;

FIG. 5 illustrates dense geometry format, according to an example;

FIGS. 6A-6C illustrate different techniques for subdividing geometry; and

FIG. 7 illustrates a technique for compressing and decompressing geometry.

### DETAILED DESCRIPTION

Dense geometry format is a compression format for geometry. The compression format stores geometry (e.g., primitives or triangles) in compressed data structures. The compression format eliminates the need to store duplicate vertex information by storing unique vertices in each compressed data structure. Triangles are represented in the format using topology information that includes, for example, a list of references (“indices”) to the unique vertices. Different triangles refer to the same vertex using an index. Thus, even if the same vertex is used in different triangles, the compressed data structure does not need to store all information (e.g., positional information) for each vertex multiple times. Instead, by storing indices for the triangles, duplicated inclusion of vertex data is eliminated, since an index consumes much less data than the full data for each vertex.

It is possible to use the geometry that is specified by the compressed data structure as a base mesh for subdivision. A base mesh for subdivision is a mesh (collection of primitives) that is used to generate additional detailed geometry in a subdivision process. Generating such additional detailed geometry would be performed using techniques such as tessellation, and would be performed as specified in subdivision metadata. In various examples, the subdivision metadata specifies how the geometry is subdivided. In some examples, the subdivision metadata also specifies how to displace the vertices that result from such subdivision to form a surface. To specify how the geometry is subdivided, the subdivision metadata indicates either implicit subdivision type (e.g., that the geometry is subdivided by loop, grid, or Catmull-Clark subdivision, described further herein) or indicates explicit subdivision information, such as tessellation factors for edges of the geometry. In some examples, the subdivision metadata specifies different ways to subdivide the geometry for different portions of the geometry. In some such examples, the subdivision metadata includes different subdivision information for different portions of the geometry, such as for different primitives. Subdividing geometry that is already compressed in this manner provides an extremely efficient way to store very detailed geometry.

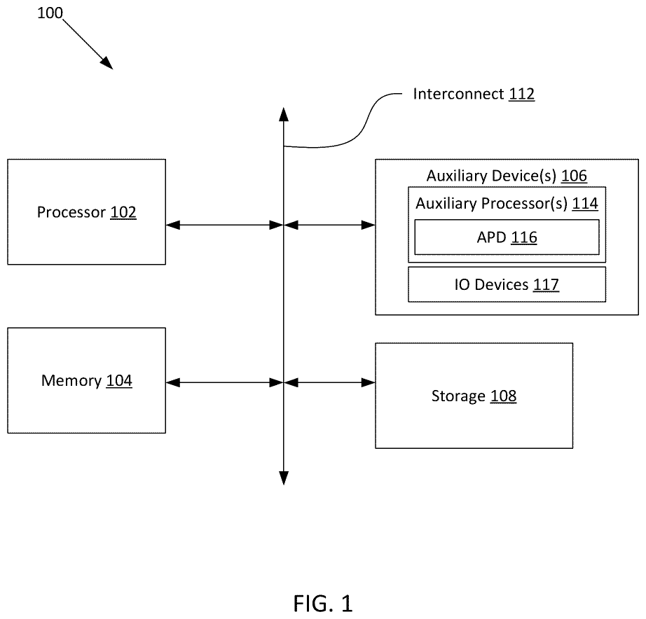

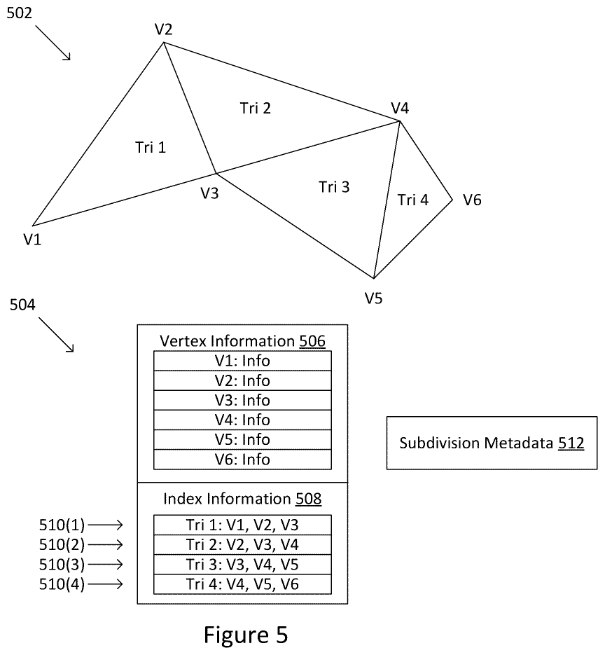

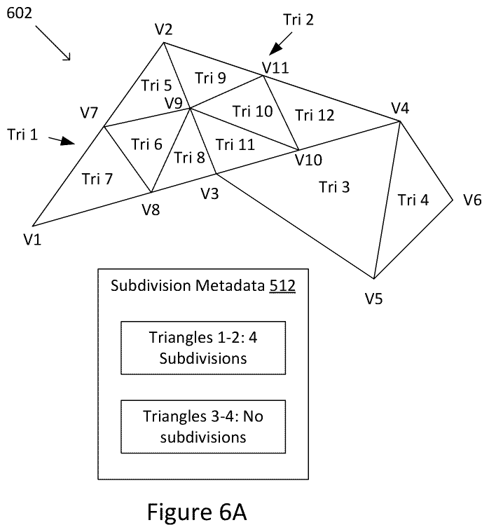

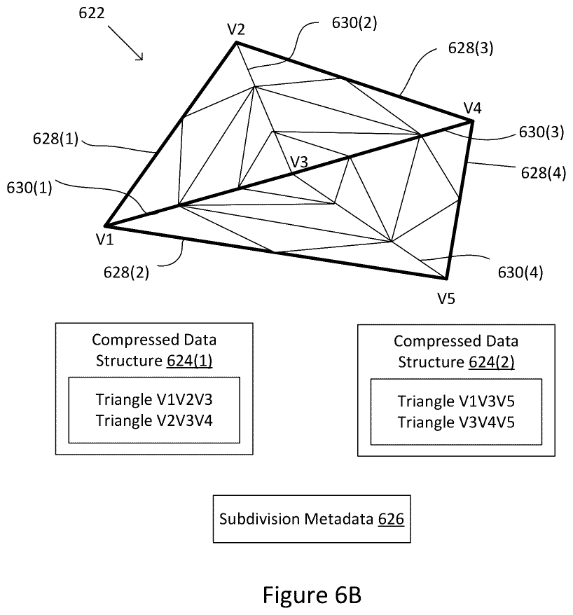

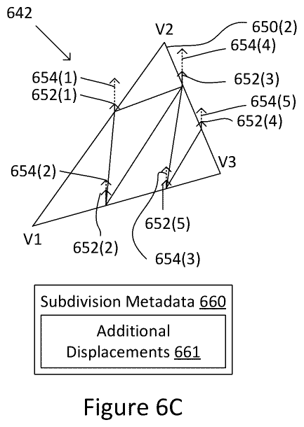

FIGS. 1-4 describe an example system in which the compression technique can be used. FIG. 5 describes the dense geometry format. FIGS. 6A-6C describe different forms of subdivision. FIG. 8 describes a method for performing compression and decompression operations for the dense geometry format.

FIG. 1 is a block diagram of an example computing device 100 in which one or more features of the disclosure can be implemented. In various examples, the computing device 100 is one of, but is not limited to, for example, a computer, a gaming device, a handheld device, a set-top box, a television, a mobile phone, a tablet computer, or other computing device. The device 100 includes, without limitation, one or more processors 102, a memory 104, one or more auxiliary devices 106, and a storage 108. An interconnect 112, which can be a bus, a combination of buses, and/or any other communication component, communicatively links the one or more processors 102, the memory 104, the one or more auxiliary devices 106, and the storage 108.

In various alternatives, the one or more processors 102 include a central processing unit (CPU), a graphics processing unit (GPU), a CPU and GPU located on the same die, or one or more processor cores, wherein each processor core can be a CPU, a GPU, or a neural processor. In various alternatives, at least part of the memory 104 is located on the same die as one or more of the one or more processors 102, such as on the same chip or in an interposer arrangement, and/or at least part of the memory 104 is located separately from the one or more processors 102. The memory 104 includes a volatile or non-volatile memory, for example, random access memory (RAM), dynamic RAM, or a cache.

The storage 108 includes a fixed or removable storage, for example, without limitation, a hard disk drive, a solid state drive, an optical disk, or a flash drive. The one or more auxiliary devices 106 include, without limitation, one or more auxiliary processors 114, and/or one or more input/output (“IO”) devices. The auxiliary processors 114 include, without limitation, a processing unit capable of executing instructions, such as a central processing unit, graphics processing unit, parallel processing unit capable of performing compute shader operations in a single-instruction-multiple-data form, multimedia accelerators such as video encoding or decoding accelerators, or any other processor. Any auxiliary processor 114 is implementable as a programmable processor that executes instructions, a fixed function processor that processes data according to fixed hardware circuitry, a combination thereof, or any other type of processor.

The one or more auxiliary devices 106 includes an accelerated processing device (“APD”) 116. The APD 116 may be coupled to a display device, which, in some examples, is a physical display device or a simulated device that uses a remote display protocol to show output. The APD 116 is configured to accept compute commands and/or graphics rendering commands from processor 102, to process those compute and graphics rendering commands, and, in some implementations, to provide pixel output to a display device for display. As described in further detail below, the APD 116 includes one or more parallel processing units configured to perform computations in accordance with, for example, a single-instruction-multiple-data (“SIMD”) or a single-instruction-multiple-thread (“SIMT”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and, optionally, configured to provide graphical output to a display device. For example, it is contemplated that any processing system that performs processing tasks in accordance with a SIMD paradigm may be configured to perform the functionality described herein. Alternatively, it is contemplated that computing systems that do not perform processing tasks in accordance with a SIMD paradigm perform the functionality described herein.

The one or more IO devices 117 include one or more input devices, such as a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals), and/or one or more output devices such as a display device, a speaker, a printer, a haptic feedback device, one or more lights, an antenna, or a network connection (e.g., a wireless local area network card for transmission and/or reception of wireless IEEE 802 signals).

As described in further detail below, the APD 116 includes one or more parallel processing units to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and provides graphical output to a display device 118. For example, it is contemplated that any processing system that performs processing tasks in accordance with a SIMD paradigm may perform the functionality described herein. Alternatively, it is contemplated that computing systems that do not perform processing tasks in accordance with a SIMD paradigm performs the functionality described herein.

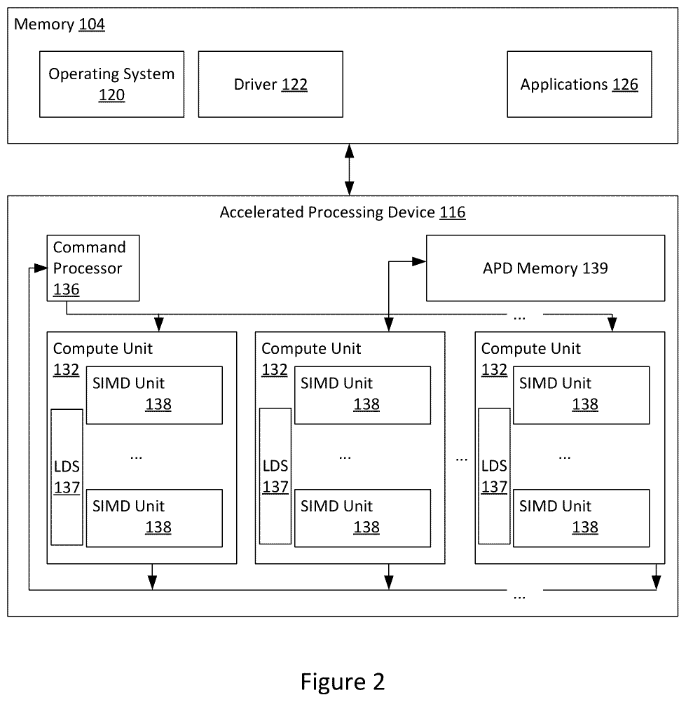

FIG. 2 is a block diagram of the device 100, illustrating additional details related to execution of processing tasks on the APD 116, according to an example. The processor 102 maintains, in system memory 104, one or more control logic modules for execution by the processor 102. The control logic modules include an operating system 120, a driver 122, and applications 126. These control logic modules control various features of the operation of the processor 102 and the APD 116. For example, the operating system 120 directly communicates with hardware and provides an interface to the hardware for other software executing on the processor 102. The driver 122 controls operation of the APD 116 by, for example, providing an application programming interface (“API”) to software (e.g., applications 126) executing on the processor 102 to access various functionality of the APD 116. In some examples, the driver 122 also includes a just-in-time compiler that compiles programs for execution by processing components (such as the SIMD units 138 discussed in further detail below) of the APD 116.

The APD 116 executes commands and programs for selected functions, such as graphics operations and non-graphics operations that may be suited for parallel processing. The APD 116 can be used for executing graphics pipeline operations such as pixel operations, geometric computations, and rendering an image based on commands received from the processor 102. The APD 116 also executes compute processing operations that are not directly related to graphics operations, such as operations related to video, physics simulations, computational fluid dynamics, neural computing, artificial intelligence (AI) tasks, or other tasks, based on commands received from the processor 102. In some examples, the APD 116 does not perform graphics operations.

In this example, the APD 116 includes compute units 132 that include one or more SIMD units 138 that perform operations at the request of the processor 102 in a parallel manner according to a SIMD paradigm. The compute units 132 are sometimes referred to as “parallel processing units” herein. Each compute unit 132 includes a local data share (“LDS”) 137 that is accessible to wavefronts executing in the compute unit 132 but not to wavefronts executing in other compute units 132. A global memory 139 stores data that is accessible to wavefronts executing on all compute units 132. In some examples, the local data share 137 has faster access characteristics than the global memory 139 (e.g., lower latency and/or higher bandwidth). Although shown in the APD 116, the global memory 139 can be partially or fully located in other elements, such as in system memory 104 or in another memory not shown or described. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program that is to be executed in parallel in a particular lane. Work-items can be executed simultaneously as a “wavefront” on a single SIMD processing unit 138. One or more wavefronts are included in a “work group,” which includes a collection of work-items designated to execute the same program. A work group can be executed by executing each of the wavefronts that make up the work group. In alternatives, the wavefronts are executed sequentially on a single SIMD unit 138 or partially or fully in parallel on different SIMD units 138. Wavefronts can be thought of as the largest collection of work-items that can be executed simultaneously on a single SIMD unit 138. Thus, if commands received from the processor 102 indicate that a particular program is to be parallelized to such a degree that the program cannot execute on a single SIMD unit 138 simultaneously, then that program is broken up into wavefronts which are parallelized on two or more SIMD units 138 or serialized on the same SIMD unit 138 (or both parallelized and serialized as needed). A scheduler 136 performs operations related to scheduling various wavefronts on different compute units 132 and SIMD units 138.

The parallelism afforded by the compute units 132 is suitable for graphics related operations such as pixel value calculations, vertex transformations, and other graphics operations as well as various compute or AI operations. Thus in some instances, a graphics pipeline, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline (e.g., custom operations performed to supplement processing performed for operation of the graphics pipeline). An application 126 or other software executing on the processor 102 transmits programs that define such computation tasks to the APD 116 for execution.

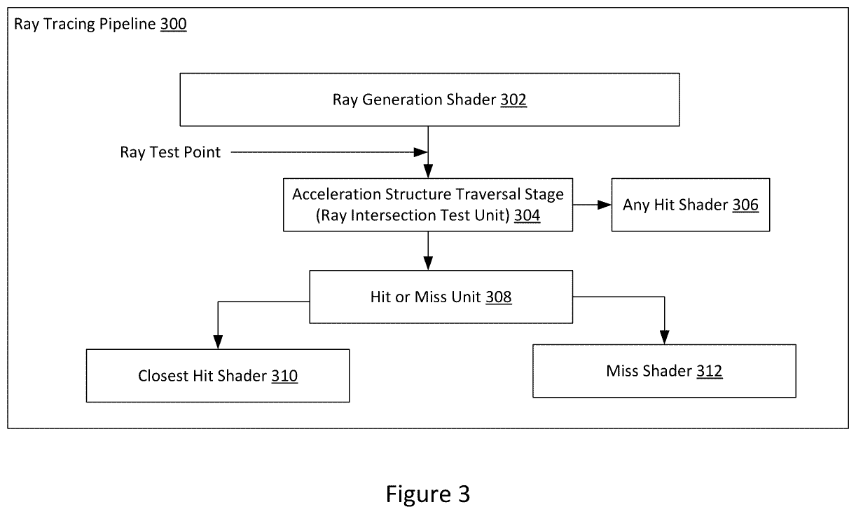

FIG. 3 illustrates a ray tracing pipeline 300 for rendering graphics using a ray tracing technique, according to an example. The ray tracing pipeline 300 provides an overview of operations and entities involved in rendering a scene utilizing ray tracing. A ray generation shader 302, any hit shader 306, closest hit shader 310, and miss shader 312 are shader-implemented stages that represent ray tracing pipeline stages whose functionality is performed by shader programs executing in the SIMD unit 138. Any of the specific shader programs at each particular shader-implemented stage are defined by application-provided code (i.e., by code provided by an application developer that is pre-compiled by an application compiler and/or compiled by the driver 122). The acceleration structure traversal stage 304 performs a ray intersection test to determine whether a ray hits a triangle.

Any portion of the ray tracing pipeline 300 is implemented as software, hardware (e.g., circuitry such as a programmable or non-programmable processor, of fixed function circuitry) or a combination thereof, and can be implemented partially or fully on the APD 116. In various such examples, the software executes on the SIMD units 138 and/or on a different processor. More specifically, the various programmable shader stages (ray generation shader 302, any hit shader 306, closest hit shader 310, miss shader 312) are implemented as shader programs that execute on the SIMD units 138. The acceleration structure traversal stage 304 is implemented in software (e.g., as a shader program executing on the SIMD units 138), in hardware, or as a combination of hardware and software. The hit or miss unit 308 is implemented in any technically feasible manner, such as part of any of the other units, implemented as a hardware accelerated structure, or implemented as a shader program executing on the SIMD units 138. The ray tracing pipeline 300 may be orchestrated partially or fully in software or partially or fully in hardware, and may be orchestrated by the processor 102, the scheduler 136, by a combination thereof, or partially or fully by any other hardware and/or software unit. The term “ray tracing pipeline processor” used herein refers to a processor executing software to perform the operations of the ray tracing pipeline 300, hardware circuitry hard-wired to perform the operations of the ray tracing pipeline 300, or a combination of hardware and software that together perform the operations of the ray tracing pipeline 300.

The ray tracing pipeline 300 operates in the following manner. A ray generation shader 302 is executed. The ray generation shader 302 sets up data for a ray to test against a triangle or procedural primitive and requests the acceleration structure traversal stage 304 test the ray for intersection with triangles.

The acceleration structure traversal stage 304 traverses an acceleration structure, which is a data structure that describes a scene volume and objects (such as triangles) within the scene, and tests the ray against triangles in the scene. In various examples, the acceleration structure is a bounding volume hierarchy. The hit or miss unit 308, which, in some implementations, is part of the acceleration structure traversal stage 304, determines whether the results of the acceleration structure traversal stage 304 (which may include raw data such as barycentric coordinates and a potential time to hit) actually indicates a hit. For triangles that are hit, the ray tracing pipeline 300 triggers execution of an any hit shader 306. Note that multiple triangles can be hit by a single ray. It is not guaranteed that the acceleration structure traversal stage will traverse the acceleration structure in the order from closest-to-ray-origin to farthest-from-ray-origin. The hit or miss unit 308 triggers execution of a closest hit shader 310 for the triangle closest to the origin of the ray that the ray hits, or, if no triangles were hit, triggers a miss shader.

Note, it is possible for the any hit shader 306 to “reject” a hit from the ray intersection test unit 304, and thus the hit or miss unit 308 triggers execution of the miss shader 312 if no hits are found or accepted by the ray intersection test unit 304. An example circumstance in which an any hit shader 306 may “reject” a hit is when at least a portion of a triangle that the ray intersection test unit 304 reports as being hit is fully transparent. Because the ray intersection test unit 304 only tests geometry, and not transparency, the any hit shader 306 that is invoked due to a hit on a triangle having at least some transparency may determine that the reported hit is actually not a hit due to “hitting” on a transparent portion of the triangle. A typical use for the closest hit shader 310 is to color a material based on a texture for the material. Another use is to spawn additional rays for reflections and/or global illumination effects. A typical use for the miss shader 312 is to color a pixel with a color set by a skybox. It should be understood that the shader programs defined for the closest hit shader 310 and miss shader 312 may implement a wide variety of techniques for coloring pixels and/or performing other operations.

A typical way in which ray generation shaders 302 generate rays is with a technique referred to as backwards ray tracing. In backwards ray tracing, the ray generation shader 302 generates a ray having an origin at the point of the camera. The point at which the ray intersects a plane defined to correspond to the screen defines the pixel on the screen whose color the ray is being used to determine. If the ray hits an object, that pixel is colored based on the closest hit shader 310. If the ray does not hit an object, the pixel is colored based on the miss shader 312. Multiple rays may be cast per pixel, with the final color of the pixel being determined by some combination of the colors determined for each of the rays of the pixel. As described elsewhere herein, it is possible for individual rays to generate multiple samples, which each sample indicating whether the ray hits a triangle or does not hit a triangle. In an example, a ray is cast with four samples. Two such samples hit a triangle and two do not. The triangle color thus contributes only partially (for example, 50%) to the final color of the pixel, with the other portion of the color being determined based on the triangles hit by the other samples, or, if no triangles are hit, then by a miss shader. In some examples, rendering a scene involves casting at least one ray for each of a plurality of pixels of an image to obtain colors for each pixel. In some examples, multiple rays are cast for each pixel to obtain multiple colors per pixel for a multi-sample render target. In some such examples, at some later time, the multi-sample render target is compressed through color blending to obtain a single-sample image for display or further processing. While it is possible to obtain multiple samples per pixel by casting multiple rays per pixel, techniques are provided herein for obtaining multiple samples per ray so that multiple samples are obtained per pixel by casting only one ray. It is possible to perform such a task multiple times to obtain additional samples per pixel. More specifically, it is possible to cast multiple rays per pixel and to obtain multiple samples per ray such that the total number of samples obtained per pixel is the number of samples per ray multiplied by the number of rays per pixel.

It is possible for any of the any hit shader 306, closest hit shader 310, and miss shader 312, to spawn their own rays, which enter the ray tracing pipeline 300 at the ray test point. These rays can be used for any purpose. One common use is to implement environmental lighting or reflections. In an example, when a closest hit shader 310 is invoked, the closest hit shader 310 spawns rays in various directions. For each object, or a light, hit by the spawned rays, the closest hit shader 310 adds the lighting intensity and color to the pixel corresponding to the closest hit shader 310. It should be understood that although some examples of ways in which the various components of the ray tracing pipeline 300 can be used to render a scene have been described, any of a wide variety of techniques may alternatively be used.

As described above, the determination of whether a ray hits an object is referred to herein as a “ray intersection test.” The ray intersection test involves shooting a ray from an origin and determining whether the ray hits a triangle and, if so, what distance from the origin the triangle hit is at. For efficiency, the ray tracing test uses a representation of space referred to as a bounding volume hierarchy. This bounding volume hierarchy is the “acceleration structure” described above. In a bounding volume hierarchy, each non-leaf node represents an axis aligned bounding box that bounds the geometry of all children of that node. In an example, the base node represents the maximal extents of an entire region for which the ray intersection test is being performed. In this example, the base node has two children that each represent mutually exclusive axis aligned bounding boxes that subdivide the entire region. Each of those two children has two child nodes that represent axis aligned bounding boxes that subdivide the space of their parents, and so on. Leaf nodes represent a triangle against which a ray test can be performed. It should be understood that where a first node points to a second node, the first node is considered to be the parent of the second node.

The bounding volume hierarchy data structure allows the number of ray-triangle intersections (which are complex and thus expensive in terms of processing resources) to be reduced as compared with a scenario in which no such data structure were used and therefore all triangles in a scene would have to be tested against the ray. Specifically, if a ray does not intersect a particular bounding box, and that bounding box bounds a large number of triangles, then all triangles in that box can be eliminated from the test. Thus, a ray intersection test is performed as a sequence of tests of the ray against axis-aligned bounding boxes, followed by tests against triangles.

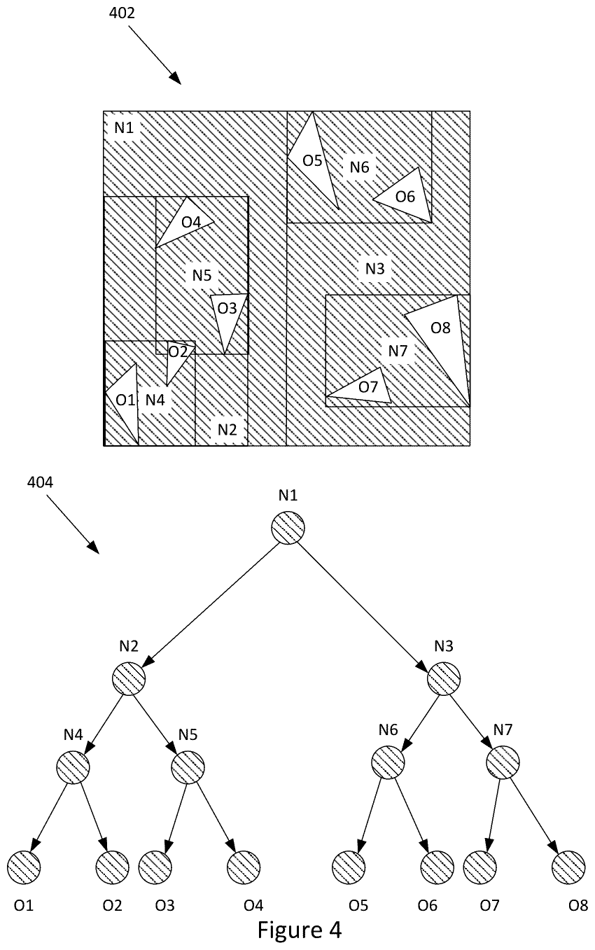

FIG. 4 is an illustration of a bounding volume hierarchy, according to an example. For simplicity, the hierarchy is shown in 2D. However, extension to 3D is simple, and it should be understood that the tests described herein would generally be performed in three dimensions.

The spatial representation 402 of the bounding volume hierarchy is illustrated in the left side of FIG. 4 and the tree representation 404 of the bounding volume hierarchy is illustrated in the right side of FIG. 4. The non-leaf nodes are represented with the letter “N” and the leaf nodes are represented with the letter “O” in both the spatial representation 402 and the tree representation 404. A ray intersection test would be performed by traversing through the tree 404, and, for each non-leaf node tested, eliminating branches below that node if the box test for that non-leaf node fails. For leaf nodes that are not eliminated, a ray-triangle intersection test is performed to determine whether the ray intersects the triangle at that leaf node.

In an example, the ray intersects O₅ but no other triangle. The test would test against N₁, determining that that test succeeds. The test would test against N₂, determining that the test fails (since O₅ is not within N₁). The test would eliminate all sub-nodes of N₂ and would test against N₃, noting that that test succeeds. The test would test N₆ and N₇, noting that No succeeds but N₇ fails. The test would test O₅ and O₆, noting that O₅ succeeds but O₆ fails. Instead of testing 8 triangle tests, two triangle tests (O₅ and O₆) and five box tests (N₁, N₂, N₃, N₆, and N₇) are performed.

Geometry data of the leaf nodes can be compressed, which improves the memory or storage utilization and transfer bandwidth characteristics of the BVH. As described above, the leaf nodes of the BVH refer to primitives that can be rendered. It is possible that a leaf node refers to a compressed data structure that stores data for one or more primitives. More specifically, the compressed data structure includes information that specifies one or more triangles, and each leaf node of the BVH of FIG. 4 refers to one of the triangles in such a compressed data structure. To use such a compressed data structure, an device (e.g., device 100) compresses geometry into such compressed data structures. A BVH builder (e.g., software, hardware (such as circuitry), or a combination thereof) builds a BVH where the leaf nodes reference primitives in the compressed data structure. At render time, the ray tracing pipeline 400 arrives at a leaf node which specifies a triangle of a compressed data structure. The ray tracing pipeline 400 decompresses the compressed data structure to obtain an uncompressed primitive and performs operations for that primitive such as performing an intersection test or performing shading based on an intersected primitive. It should be understood that any particular compressed data structure can be referenced by one or multiple leaf nodes. Each leaf node would identify which primitive of the compressed data structure is associated with that leaf node and the decompression thus obtains the primitive data for that identified primitive when necessary.

FIG. 5 is a diagram illustrating aspects of a compressed data structure for storing primitive information, according to an example. FIG. 5 illustrates a set of triangles 502 and a compressed data structure 504 representing the set of triangles 502. The set of triangles 502 includes triangle 1, triangle 2, triangle 3, and triangle 4. Triangle 1 is composed of vertices V1, V2, and V3. Triangle 2 is composed of vertices V2, V3, and V4. Triangle 3 is composed of vertices V3, V4, and V5. Triangle 4 is composed of vertices V4, V5, and V6. In FIG. 5 (and elsewhere herein), triangles are labeled “tri X” (where X is a number).

The compressed data structure 504 includes information for these triangles. Specifically, the compressed data structure 504 includes vertex information 506 and index information 508. The vertex information 506 includes actual information about vertices, such as position information. The index information 508, which is also sometimes referred to as “topology information” herein, indicates which vertices of the vertex information 506 make up the triangles represented by the compressed data structure 504. More specifically, the index information 508 includes triangle elements 510, each of which includes reference to vertices of the vertex information 506. In other words, each triangle element 510 includes a reference to a set of vertices, where that set of vertices together comprises a triangle.

In addition to the above, it is possible to represent all positional information for the vertices of the vertex information 506 in a fixed-point number space, rather than as floating-point numbers. The fixed-point number space is a “virtual grid” in which every increment of a number in the space has the same difference (rather than with floating point numbers, where the difference between adjacent representable values varies with the magnitude of the number). The fixed-point number space allows for a smaller number of bits to be used (e.g., 16 instead of 32) to represent the coordinate values for the vertices. In some examples, the vertex information 506 also includes a minimum and maximum value for all vertices in the vertex information 506, so that the fixed-point numbers, interpreted in light of these minimum and maximum values, are able to represent a large number of possible values.

As can be seen, the triangles in a compressed data structure 504 are represented in FIG. 5 with a set of vertex information 506 and a set of index information 508. The full set of information (e.g., parameters such as coordinates, material ID, or the like) for each vertex is included only once in each compressed data structure 504. For vertices used in multiple triangles, this information is effectively “de-duplicated” by referring to such vertices by reference in the triangle elements 510.

Although a set of explicit indices is shown, it is also possible to represent topology information with implicit indications of topology. In such examples, an implicit indication indicates the manner in which the vertex information 506 is combined to form triangles without using explicit indices for each vertices of such triangle. In an example, the implicit indication indicates a topology that indicates which triangles are formed by which vertices, based on the order of the vertices. In other words, instead of explicitly indicating exactly which vertices comprise which triangles, the implicit indication indicates a particular topology, which dictates how the order of the vertices determines which triangles are formed from such triangles. In an example, a topology indicates that the first three vertices (V0, V1, V2) form a triangle, and then a set of vertices shifted over by one (V1, V2, V3) form another triangle, and so on.

It is possible to use the geometry specified by one or more compressed data structure 504 storing information in dense geometry format as a base mesh for subdivision. More specifically, it is possible to include information that indicates how to derive additional geometry, in a subdivision process, from the geometry specified in the dense geometry format. Specifically, through the use of subdivision metadata 512, such additional geometry can be specified. In different examples, the subdivision metadata 512 can be included in the compressed data structure 504 or can be in a different location.

The subdivision metadata 512 represents information used for subdividing the primitives of the mesh 502 (also referred to as “triangles 502” or “set of triangles 502”) that corresponds to the compressed data structure 504 in order to represent even finer geometry. In some examples, such subdivision is called tessellation. Such subdivision involves creation of new primitives through subdivision of one or more primitives of the mesh 502. In an example, such subdivision involves subdividing triangle 1 (“Tri1,” consisting of vertices V1, V2, and V3) to form additional triangles (such as four additional triangles). In some examples, the subdivision metadata 512 has different portions that are each specific to different portions (e.g., sets of triangles) within the mesh 502. In other words, in some examples, the subdivision metadata 512 includes one portion that specifies how one set of triangles of a mesh 502 is subdivided, another portion that specifies how a different set of triangles of the mesh 502 is subdivided, and so on. In some examples, the subdivision metadata 512 specifies how many sub-edges the edges of the mesh 502 are to be divided into. In some examples, the subdivision metadata 512 specifies a first number of subdivisions to apply to the interior edges of a mesh and a second number, different than the first number, of subdivisions to apply to the border edges of the mesh. In some examples, the “border edges” are the external edges specified in the compressed data structure (e.g., edges V1-V2, V1-V3, V2-V4, V3-V5, V4-V6, and V5-V6 of mesh 502). In some examples, multiple compressed data structures 504 specify different portions of a mesh. In such examples, it is the border edges of that overall mesh that have a different number of subdivisions than the interior edges of that mesh. In other words, as described above, the subdivision metadata 512 specifies a first number of subdivisions for the border edges, where such border edges are at the border of the mesh that spans multiple compressed subdivisions and the interior edges are those that are within such mesh. In some examples, the subdivision metadata has an indication of the subdivision type for the subdivisions. In some examples, the subdivision types include one or more of loop, grid, or Catmull-Clark subdivision. In some examples, one or more such subdivision types are associated with a curved surface topology referred to as the “limit surface,” whose name derives from the fact that if the surface were subdivided infinitely and all the vertices were displaced appropriately, such a surface would be formed. In the process of subdividing the mesh, the vertices are generated at subdivision points and displaced to positions to match the “limit surface.” In some examples, additional displacements per vertex are provided on top of the displacements needed to reach the limit surface. In various examples, these additional displacements are placed within the subdivision metadata 512 or in a side channel, such as in some other data structure.

FIG. 6A illustrates a subdivided mesh 602 according to an example. The mesh 602 has the same base vertices as the mesh 502 (e.g., vertices V1-V6), but, because the subdivision metadata 512 defines additional subdivisions, additional such subdivisions are shown. Specifically, the subdivision metadata 512 indicates that the edges of original triangles Tri 1 and Tri 2 should be subdivided into two edges and that the vertices that result from such subdivisions should form triangles with the vertices of the original triangles to form new, subdivided triangles. This results in the original triangle Tri 1 having four triangle subdivisions (Tri 5-Tri 8) and the original triangle Tri 2 having four triangle subdivisions (Tri 9-Tri 12). Thus, on top of the vertices of mesh 502, the mesh represented by a compressed data structure that includes the subdivision metadata 512 includes vertices V7-V10, subdividing triangles Tri1 and Tri2 as shown.

It should be understood that the subdivision metadata 512 can specify any degree of edge subdivision (e.g., that edges are divided into two sub-edges, three sub-edges, and so-on), and that such specification can apply to any edges in the mesh 602. Moreover, the subdivision metadata 512 can specify any number of subdivision for any particular edge in the mesh 602, and can thus specify different numbers of subdivisions for different edge of the same mesh 602. It should be understood that in some examples, the resulting subdivided mesh consists of the triangles formed by connecting the vertices resulting from such subdivisions, as shown.

In summary, in some examples, the subdivision metadata 512 includes information that specifies which portions of a mesh 602 are subdivided and how such portions are subdivided.

FIG. 6B illustrates a scenario in which a mesh defined by a plurality of compressed data structures 504 is subdivided using subdivision metadata 512. In this scenario, the subdivision metadata 512 specifies a number of edge subdivision for interior edges of the mesh and a different number of edge subdivisions for the border edges of the mesh.

Mesh 622 illustrates such an example of such a scenario. In mesh 622, four triangles comprise the base geometry. These triangles are defined by the following sets of vertices: V1, V2, V3 (first triangle); V2, V3, V4 (second triangle); V3, V4, V5 (third triangle); and V1, V3, and V5 (fourth triangle). In this example, a first compressed data structure 624(1) specifies the first triangle and the second triangle, and a second compressed data structure 624(2) specifies the third triangle and the fourth triangle. However, these different compressed data structure specify geometry for the same mesh (where a mesh is identified by a mesh identifier). The geometry corresponding to each compressed data structure 624 is outlined in bold.

In the scenario of FIG. 6B, the subdivision metadata 626 specifies that the border edges 628 of the mesh 622 have two subdivisions and the internal edges 630 of the mesh 622 have three subdivisions. Thus, as can be seen, the border edges 628 are subdivided into two different edges and the internal edges 630 are divided into three different edges. The resulting subdivided geometry is formed by connecting the vertices resulting from these subdivisions. Although an example way to perform such connection is shown, any technically feasible means to perform such subdivision is possible. It should be understood that the border edges 628 are edges that define the perimeter of the mesh 622, while the internal edges are a part of the base mesh that are internal to that perimeter. These internal edges are not, however, the edges that are the result of the subdivision (which are unlabeled in FIG. 6B).

It is possible for a mesh to have portions that are defined by DGF compressed data structures and other portions that are not defined by such compressed data structures (e.g., those that are not compressed or are compressed in a different way). In some such examples, subdivision metadata describes a first number of subdivisions for DGF border edges and a second number of subdivisions for internal edges. DGF border edges are edges that are at the perimeter of a DGF region of a mesh (where the DGF region is a region that includes all DGF geometry and the perimeter is the border between such a region and other portions of the same mesh). In other words, in some examples, the subdivisions metadata defines how DGF border edges are subdivided and how DGF internal edges are subdivided.

FIG. 6C illustrates a scenario in which subdivision metadata 660 indicates additional displacements 661 that are to be applied to displace from the “limit surface” that characterizes the subdivision. More specifically, a surface with subdivision applied, such as that defined by geometry 642, can have an associated limit surface, which is the surface that would exist if the surface was infinitely subdivided and each resulting vertex was displaced to create a smooth surface. In various examples, this limit surface is specified implicitly or with a small number of parameters, rather than with a specific displacement for each vertex. The additional displacements 661 of the subdivision metadata 660 indicates additional displacements, over those specified for the limit surface. In FIG. 6C, the displacements specified by the limit surface are limit displacements 652, and the additional displacements specified by the subdivision metadata 660 are displacements 654. It should be understood that, in various implementations, the additional displacements 661 illustrated in FIG. 6C is provided for one or more compressed data structures 504 in addition to the other types of subdivision metadata provided for such compressed data structures 504 (e.g., in addition to that specified in FIGS. 6A and/or 6B). Thus it is possible, for example, for subdivision metadata to specify edge tessellation factors in either or both of the manners specified in FIGS. 6A and 6B, as well as to specify additional displacements 661.

As stated above, the subdivision metadata can specify implicit subdivisions of the geometry described in the compressed data structures 504. A large number of such subdivisions are possible. A “subdivision” means a subdivision of base geometry, which indicates the pattern of triangles generated from a set of vertices. In an example, the subdivision indicates a “loop” based subdivision of a triangle, where subsequent vertices are part of increasingly smaller triangles that subdivide larger triangles. In another example, the subdivision indicates a grid-based triangle or quad, where the vertices define a column-by-column and row-by-row set of vertices. In another example, the subdivision indicates a Catmull-Clark-based subdivision, in which the edges of triangles or quads of the base geometry are subdivided, further primitives are generated from such subdivisions, and the vertices of such subdivisions are displaced to approximate a limit surface. Although some example subdivisions are described, it should be understood that a variety of subdivisions are possible.

In some examples, the operations for GDF compressed geometry, including the additional subdivision, are performed in fixed point. Fixed point numbers are numbers where the increment between neighboring binary representations of such numbers is uniform. In other words, the increment for any two given fixed-point numbers whose binary representation are immediate neighbors is the same for any two such numbers. In an example, the fixed point number 0000 and the fixed point number 0001 has a binary increment of 1, and the numerical value of this number difference is 1/16 (since 0000 represents 0 and 0001 represents 1/16). In such an example, all such increments have a difference of 1/16, so that the number 1000 ( 8/16) and the immediately higher number 1001 ( 9/16) also has a 1/16 increment. This is in contrast to floating point numbers, where the difference between immediately neighboring numbers varies based on the magnitude of the number. Fixed point numbers generally utilize a fixed rational value to represent the increment between immediate neighbors.

The fact that fixed point numbers are used for the geometry means that all such geometry is considered to be on a “grid.” In other words, since all values have equal spacing between adjacent values, the entire number space creates a grid for three-dimensional values (e.g., vertices of triangles or other geometries). In some examples, this “grid” is the basis for all operations involved with the compression/decompression. In other words, the geometry that is compressed into the compressed data structure is placed onto such a grid. Further, the geometry that is decompressed into decompressed geometry remains on that grid, and the subdivided geometry that results from subdividing the geometry is also on that grid. In some examples where hardware (rather than software) is used to perform the subdivision, that hardware operates in the fixed point space and produces geometry results in that fixed point space. In various examples, such data may finally be converted to a floating point space and used (e.g., for rendering) or the data may remain in the fixed point space and used (e.g., for rendering).

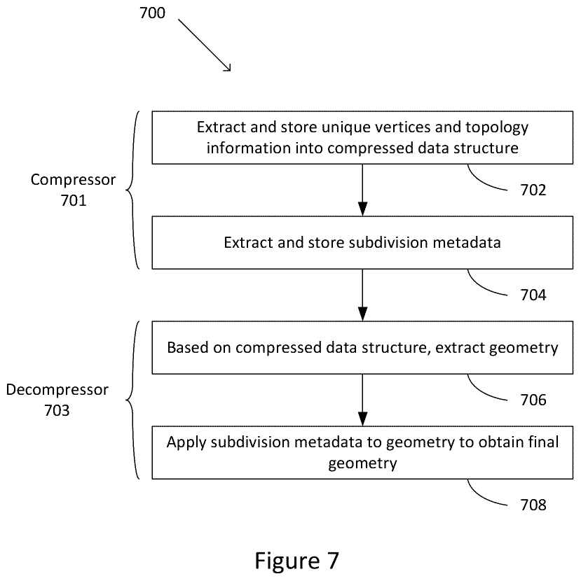

FIG. 7 is a flow diagram of a method 700 for processing geometry, according to an example. Although described with respect to the system of FIGS. 1-6C, those of skill in the art will recognize that any system configured to perform the steps of the method 700 in any technically feasible order falls within the scope of the present disclosure.

At step 702, a compressor 701 extracts and stores unique vertices and topology information into a compressed data structure (e.g., structure 504). In various examples, initial geometry is provided to the compressor 701. The initial geometry includes vertices and other information for one or more meshes. The compressor 701 generates compressed data structures by identifying the unique vertices and storing those, along with topology information (e.g., indices) into a compressed data structure.

At step 704, the compressor extracts and stores subdivision metadata. The subdivision metadata is information that indicates how to further subdivide the geometry specified by the dense geometry format compressed data structure. In some examples, the subdivision metadata specifies edge tessellation factors for different portions of such geometry. In some examples, the tessellation factors are specified as factors for DGF borders and factors for internal edges as with FIG. 6B. In some examples, tessellation factors are specified on a more particular basis (e.g., factors specified for each edge). In some examples, the subdivision metadata specifies which portions of the geometry are subdivided and which are not. In some examples, the subdivision metadata specifies a subdivision type, such as loop subdivision, grid subdivision, or Catmull-Clark. In some examples, step 704 involves “extracting” this information, either from a high definition mesh that is supplied with greater detail than the DGF base mesh, or from explicit information provided with such a mesh (e.g., where a content creator or other entity that generates the mesh(es) being compressed by the compressor 701 specifies such information explicitly). The compressor 701 stores this subdivision metadata, either at least partially within the compressed data structure itself or outside of that data structure, as described elsewhere herein.

At step 706, the decompressor 703 extracts geometry based on the compressed data structure. As described elsewhere herein, the compressed data structure specifies unique vertices and topology information. The unique vertices specify vertex information for the vertex and the topology information includes indices or other information that specifies how such vertices are connected to form primitives such as triangles. The decompressor 703 generates primitives from the unique vertices and topology information, which is the resulting geometry for the compressed data structure. Generating such primitives includes, for example, generating triangles according to the topology information, by obtaining the vertex information from the unique vertices and connecting such vertices to form primitives according to the topology information.

At step 708, the decompressor 703 applies the subdivision metadata to the geometry obtained at step 706, to obtain final geometry. Any of the techniques described with respect to FIGS. 6A-6C could be used. Such techniques include, for example, subdividing based on edge tessellation factors, subdivision based on subdivision type, or performing other subdivision. Any other technically feasible techniques described herein or elsewhere could be used.

As stated above, either or both of the decompressor 703 and the compressor 701 can operate in the fixed point number space of the DGF format.

Once the geometry is obtained, any technically feasible operation can be performed using the geometry. In an example, a rendering system such as the ray tracing pipeline 300, renders that geometry.

In various examples, the compressor 701 and decompressor 703 are separate or the same, and are a circuit (e.g., fixed-function circuit, programmable processor, fixed-function processor, programmable logic device, field programmable gate array, or any other type of circuit), software (e.g., app, application, driver, firmware, or any other type of software), or a combination thereof. In various examples, the compressor 701 is on the same system as the decompressor 703 or is on a different system than the decompressor 703.

Although the term “triangle” or “quad” is sometimes used here, this term can be replaced with “primitive” for similar, though broader meaning. The term “primitive” refers generally to geometric objects such as triangle, quad, or other geometry object.

Any technically feasible system can request the decompressor to provide such decompressed triangles from a compressed data structure. In various examples, the ray tracing pipeline obtains such primitives upon arriving at a leaf node and performs intersection tests and other operations using such primitives. In other examples, a rasterization pipeline obtains triangles from a compressed data structure and performs rendering operations such as performing vertex shading, pixel shading, and outputting to a render target. Operations other than rendering using ray tracing or rasterization could be used as well. For example, modeling software could store geometry in a compressed format and compress and decompress such geometry for storage and display as needed. Any other software or hardware could perform operations using such compressed geometry.

It should be understood that many variations are possible based on the disclosure herein. Although features and elements are described above in particular combinations, each feature or element can be used alone without the other features and elements or in various combinations with or without other features and elements.

The various functional units illustrated in the figures and/or described herein (including, but not limited to, the processor 102, the accelerated processing device 116, the scheduler 136, the compute units 132, the SIMD units 138, local data store 137, APD memory 139, ray tracing pipeline 300, ray generation shader 302, acceleration structure traversal stage 304, any hit shader 306, hit or miss unit 308, closest hit shader 310, miss shader 312, compressor 701, or decompressor 703, may be implemented as a general purpose computer, a processor, or a processor core, or as a program, software, or firmware, stored in a non-transitory computer readable medium or in another medium, executable by a general purpose computer, a processor, or a processor core. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method comprising:
extracting geometry from a compressed data structure by applying topology information to a set of unique vertices of the compressed data structure;
applying one or more subdivision operations to the geometry to obtain subdivided geometry; and
performing rendering operations utilizing the subdivided geometry.

2. The method of claim 1, wherein the topology information indicates implicit or explicit connectivity information.

3. The method of claim 1, wherein the topology information identifies which unique vertices comprise which triangles.

4. The method of claim 1, wherein the rendering operations comprise one of performing rasterization-based rendering or performing ray tracing based rendering.

5. The method of claim 1, wherein the one or more subdivision operations include one or more of a loop-based subdivision, a grid-based subdivision, or a Catmull-Clark-based subdivision.

6. The method of claim 1, wherein the one or more subdivision operations include subdividing edges of the geometry based on tessellation factors to obtain vertices and connecting the vertices to obtain subdivided geometry.

7. The method of claim 6, wherein the tessellation factors are specified differently for border regions of the geometry and for internal regions of the geometry.

8. The method of claim 1, further comprising displacing vertices of the subdivided geometry to a limit surface.

9. The method of claim 8, further comprising applying additional displacements to the vertices.

10. A system comprising:
a memory configured to store a compressed data structure; and
a processor configured to perform operations comprising:
extracting geometry from the compressed data structure by applying topology information to a set of unique vertices of the compressed data structure;
applying one or more subdivision operations to the geometry to obtain subdivided geometry; and
performing rendering operations utilizing the subdivided geometry.

11. The system of claim 10, wherein the topology information indicates implicit or explicit connectivity information.

12. The system of claim 10, wherein the topology information identifies which unique vertices comprise which triangles.

13. The system of claim 10, wherein the rendering operations comprise one of performing rasterization-based rendering or performing ray tracing based rendering.

14. The system of claim 10, wherein the one or more subdivision operations include one or more of a loop-based subdivision, a grid-based subdivision, or a Catmull-Clark-based subdivision.

15. The system of claim 10, wherein the one or more subdivision operations include subdividing edges of the geometry based on tessellation factors to obtain vertices and connecting the vertices to obtain subdivided geometry.

16. The system of claim 15, wherein the tessellation factors are specified differently for border regions of the geometry and for internal regions of the geometry.

17. The system of claim 10, wherein the operations further comprise displacing vertices of the subdivided geometry to a limit surface.

18. The system of claim 17, wherein the operations further comprise applying additional displacements to the vertices.

19. A non-transitory computer-readable medium storing instructions that, when executed by a processor, cause the processor to perform operations comprising:
extracting geometry from a compressed data structure by applying topology information to a set of unique vertices of the compressed data structure;
applying one or more subdivision operations to the geometry to obtain subdivided geometry; and
performing rendering operations utilizing the subdivided geometry.

20. The non-transitory computer-readable medium of claim 19, wherein the topology information indicates implicit or explicit connectivity information.
